(19) United States
(12) Patent Application Publication
(10) Pub. No.: US 2012/0319382 A1
(43) Pub. Date: Dec. 20, 2012

(54) Baby stroller with dual cross links

(75) Inventor: Ken Lin, Taicang City (CN)

(73) Assignee: SUZHOU ESSENS JUVENILE PRODUCTS INC.

(21) Appl. No.: 13/067,667

(22) Filed: Jun. 20, 2011

(51) Int. Cl. B62B 7/06

(52) U.S. Cl. 280/647

(57) ABSTRACT

A baby stroller includes a handlebar unit pivotally connected to a front leg unit by two joints on the front leg unit. Two support tubes are connected to the handlebar unit by two handlebar movable members on the handlebar unit. The support tubes are connected to a chassis unit by two chassis fixing members on the chassis unit. A dual cross link unit is connected to the support tubes by connection heads on the dual cross link unit. The dual cross link unit and the chassis unit are connected to the chassis fixing members by the connection heads on the dual cross link unit. The front leg unit is connected to the chassis unit by a chassis limitation member on the chassis unit. The stroller is folded to a compact size and reduces transportation cost.

### BACKGROUND OF THE INVENTION

(1) Field of the Invention

The present invention relates to a baby stroller, and more particularly, to a baby stroller with a dual cross link unit which allows the stroller to be folded in two directions simultaneously.

(2) Description of the Prior Art

There are many conventional strollers and most of the strollers are designed for providing sufficient space for the baby. However, the demand makes the stroller to be too big and the big stroller has higher manufacturing and transportation cost. Most of the conventional baby strollers can only be folded in the axial direction, and some of the baby strollers can be folded in two different directions. The folded strollers are still too big to easily store and carry. Therefore, there is a need to have a baby stroller that can be folded in two different directions and the folded stroller is small and easily to carry and store.

The present invention intends to provide a baby stroller which has a dual cross link unit and the baby stroller can be folded in two directions and the final status is compact and easily for storage.

### SUMMARY OF THE INVENTION

The present invention relates to a baby stroller and comprises a handlebar unit, a front leg unit, a chassis unit, a dual cross link unit and support tubes. The handlebar unit is pivotally connected to the front leg unit by two joints on the front leg unit and the support tubes are connected to the handlebar unit by two handlebar movable members on the handlebar unit. The support tubes are connected to the chassis unit by two chassis fixing members on the chassis unit. The dual cross link unit is connected to the support tubes by connection heads on the dual cross link unit. The dual cross link unit and the chassis unit are connected to chassis fixing members by the connection heads on the dual cross link unit. The front leg unit is connected to the chassis unit by a chassis limitation member on the chassis unit.

Preferably, the handlebar unit comprises a handlebar tube, two handlebar fixing members and two pins. The handlebar tube is connected to the handlebar fixing members and pivotably connected to the handlebar movable members. The joints each have a slot and the pins extend through the slots.

Preferably, the front leg unit comprises two front leg tubes, a first foot rest, a second foot rest, a first connection frame and a second connection frame. The front leg tubes are connected to the joints and the first connection frame. The second connection frame connected to the first foot rest which is movably connected to the second foot rest.

Preferably, the chassis unit comprises two rear leg tubes, two chassis fixing members, a front wheel unit and a rear wheel unit. The chassis limitation member is connected to the rear leg tubes and the front wheel unit is connected to the chassis limitation member. The two chassis fixing members are connected to the two rear leg tubes and the rear wheel unit is connected to the two rear leg tubes.

Preferably, the dual cross link unit comprises a first cross link and a second cross link which is pivotably connected to the first cross link. Two respective top ends of the first cross link are pivotably connected to the support tubes by the connection heads. The lower end of the second cross link is pivotably connected to the chassis fixing members by the connection heads.

When folding the stroller, the handlebar unit is pivoted about the joints on the front leg unit, and the support tubes are pivoted backward when the lower end of the handlebar unit is pivoted backward. The dual cross link unit is pivotably connected between the support tubes and the rear leg tubes of the chassis unit, so that when the support tubes are pivoted backward, the distance between the support tubes and the dual cross link unit on the rear leg tubes is increased, so that the dual cross link unit pivots the two sides of the stroller toward each other to fold the stroller.

The stroller of the present invention uses the dual cross link unit and a gear driving mechanism so that the stroller can be folded from axial direction and the transverse direction simultaneously. The folded stroller is compact for convenience of carriage, transportation and storage.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the stroller of the present invention;

FIG. 2 is an exploded view to show the stroller of the present invention;

FIG. 3 is a perspective view from the rear end of the stroller of the present invention;

FIG. 4 is a side elevational view of the stroller of the present invention;

FIG. 5 is a front elevational view of the stroller of the present invention;

FIG. 6 is a rear elevational view of the stroller of the present invention;

FIG. 7 is a perspective view to show the dual cross link unit of the present invention;

FIG. 8 shows the plan view of the expanded status of the dual cross link unit of the present invention;

FIG. 9 shows the plan view of the folded status of the dual cross link unit of the present invention;

FIG. 10 shows the plan view of the folded status of the stroller, and

FIG. 11 is a perspective view to show the folded status of the stroller.

### DETAILED DESCRIPTION OF THE PREFERRED EMBODIMENT

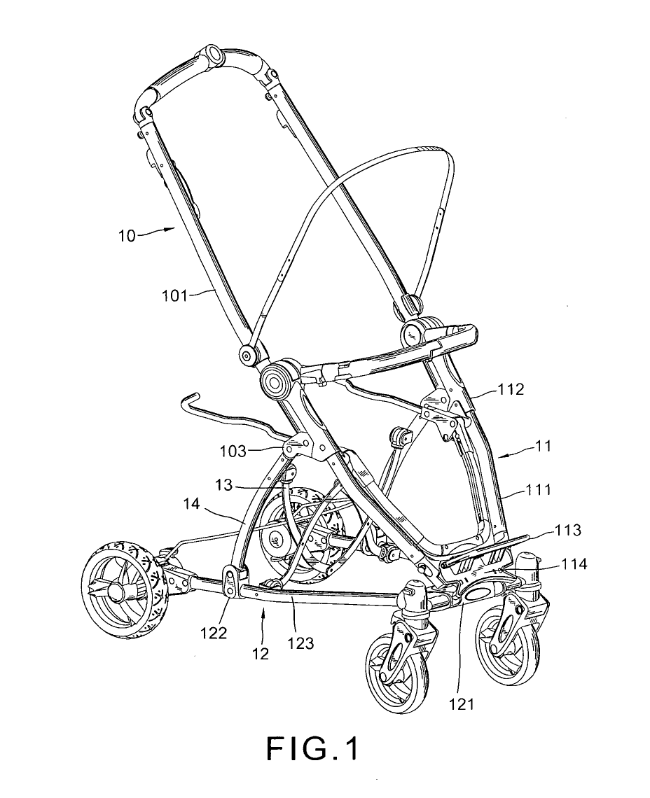

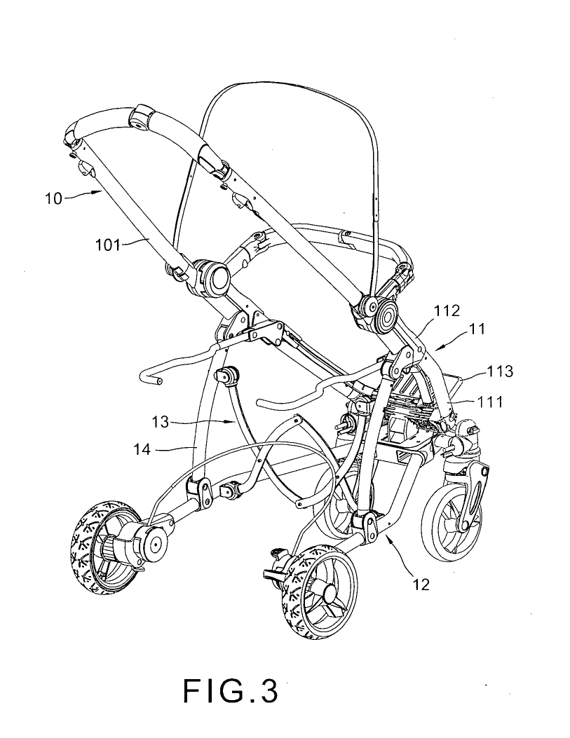

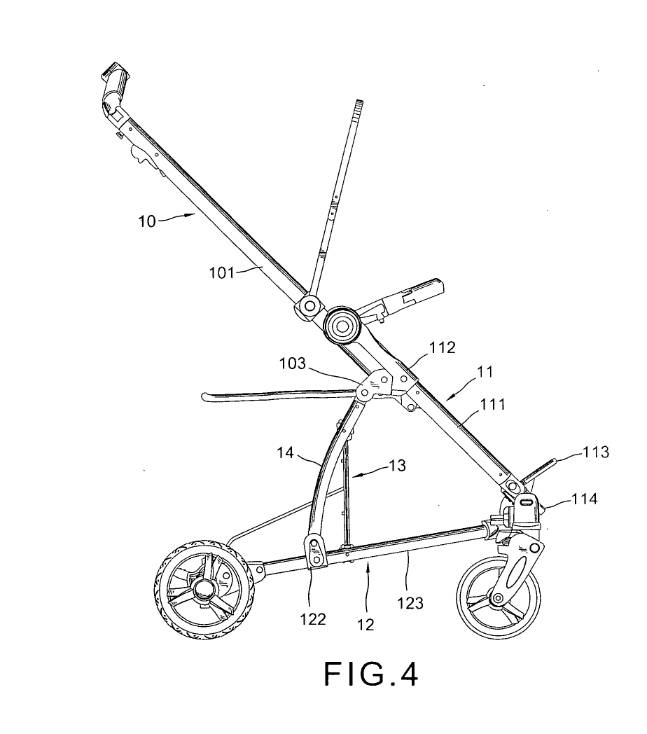

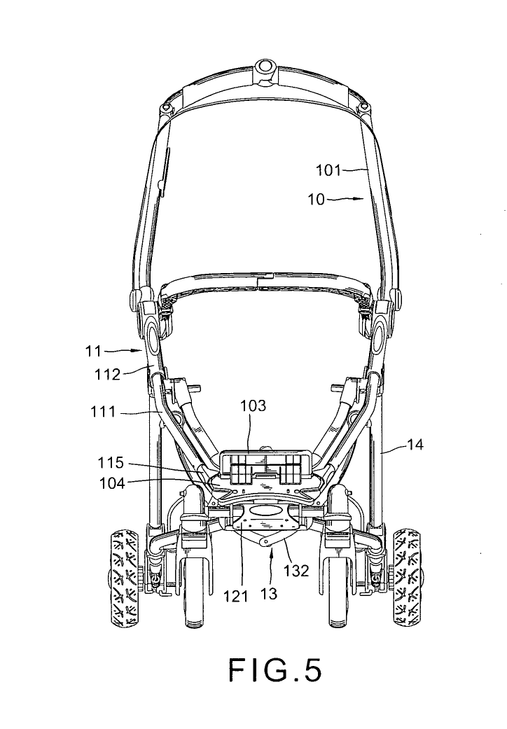

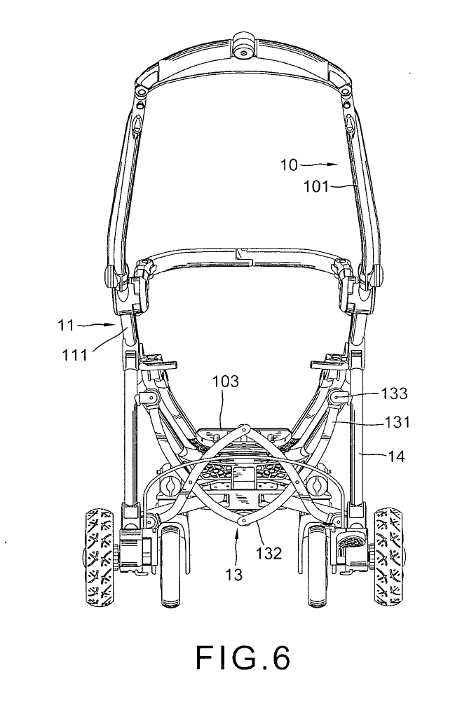

Referring to FIGS. 1 to 6, the baby stroller of the present invention comprises a handlebar unit 10, a front leg unit 11, a chassis unit 12, a dual cross link unit 13 and support tubes 14.

The handlebar unit 10 is pivotally connected to the front leg unit 11 by two joints 112 on the front leg unit 11 and comprises a handlebar tube 101, two handlebar fixing members 102 and two pins 104. The lower end of the handlebar tube 101 is connected to the handlebar fixing members 102 and pivotably connected to the handlebar movable members 103. The joints 112 each have a slot and the pins 104 extend through the slots. The handlebar tube 101 is composed of two sections which are connected to each other by plastic connector so that the handlebar tube 101 can be folded in transverse direction.

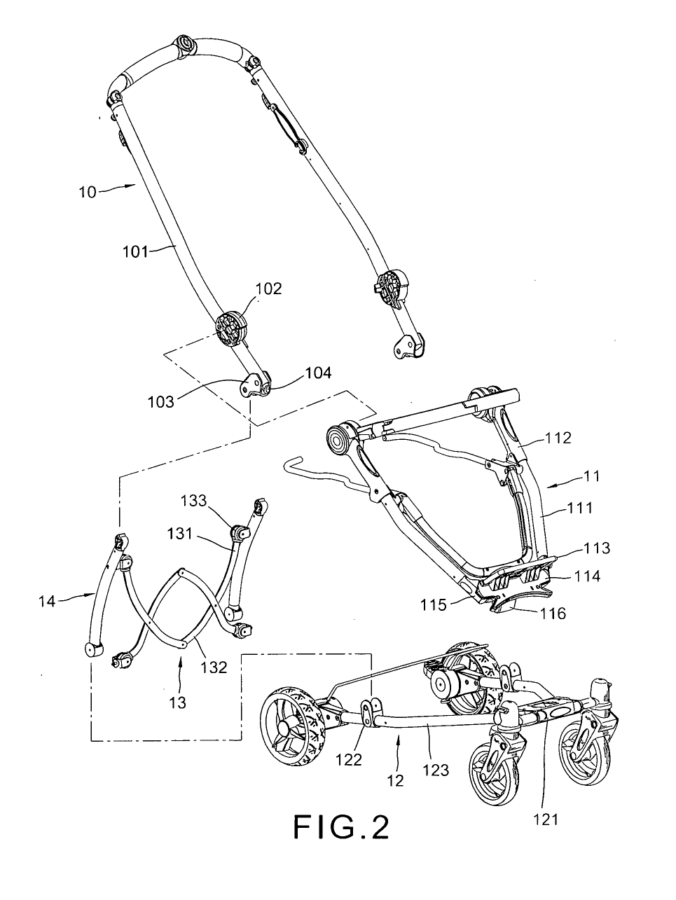

As shown in FIG. 2, the front leg unit 11 comprises two front leg tubes 111, a first foot rest 113, a second foot rest 114, a first connection frame 115 and a second connection frame 116. The front leg tubes 111 are connected to the joints 112 and the first connection frame 115. The joints 112 are pivotably connected to the handle fixing members 102. The first connection frame 115 is pivotably connected to the second connection frame 116 which is connected to the first foot rest 113 and the first foot rest 113 is movably connected to the second foot rest 114. The second foot rest 114 are pivotable about the pivots thereof.

The chassis unit 12 comprises a chassis limitation member 121, two chassis fixing members 122, two rear leg tubes 123, a rear wheel unit and rear wheels. The chassis limitation member 121 is connected to the rear leg tubes 123. The rear wheel unit is connected to the rear leg tubes 123. The chassis limitation member 121 is pivotably connected to the second connection frame 116. The front wheel unit is connected to the chassis limitation member 121. The two chassis fixing members 122 are connected to the two rear leg tubes 123.

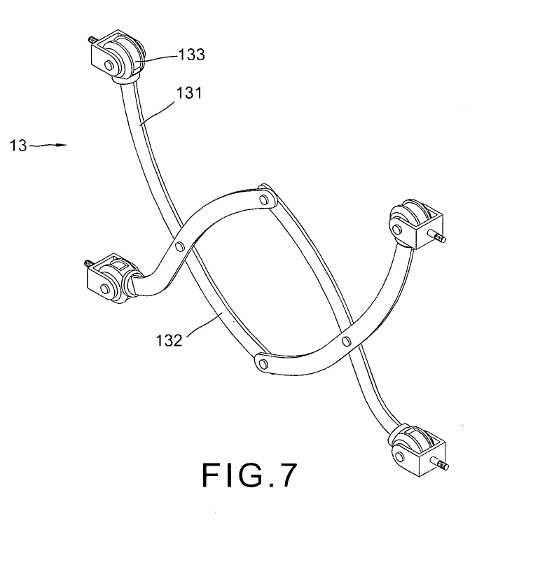

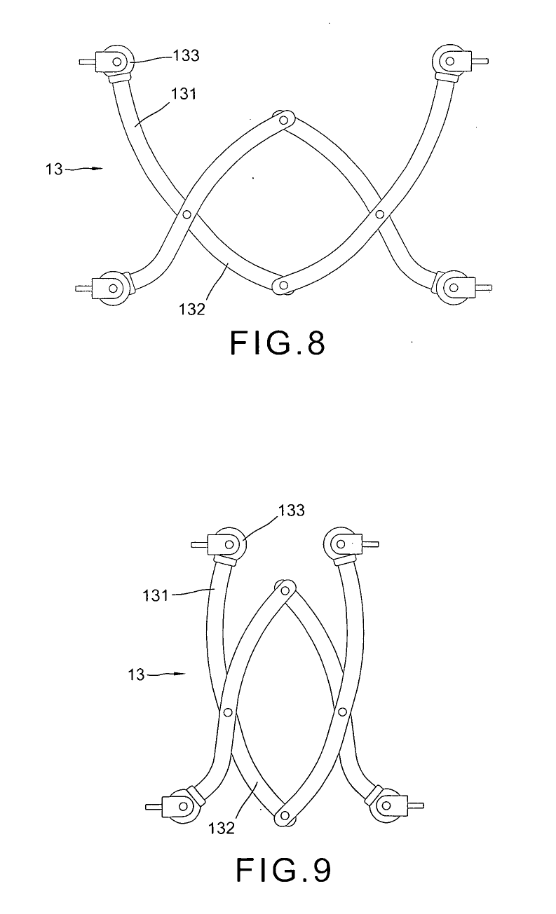

As shown in FIGS. 2, 3, 7 and 8, the dual cross link unit 13 comprises a first cross link 131, a second cross link 132 which is pivotably connected to the first cross link 131, and two connection heads 133. The two respective top ends of the first cross link 131 are pivotably connected to the support tubes 14 by the connection heads 133. A lower end of the second cross link 132 is pivotably connected to the rear leg tubes 123 by the connection heads 133. The connection heads 133 are connected to the support tubes 14 and the rear leg tubes 123 by bolts. The dual cross link unit 13 is pivotable about the bolts.

The support tubes 14 are connected to the handlebar unit 10 by two handlebar movable members 103 on the handlebar unit 10, and the support tubes 14 are connected to the chassis unit 12 by two chassis fixing members 122 on the chassis unit 12. The dual cross link unit 13 is connected to the support tubes 14 by the connection heads 133 on the dual cross link unit 13. The dual cross link unit 13 and the chassis unit 12 are connected to the rear leg tubes 123 by the connection heads 133 on the dual cross link unit 13.

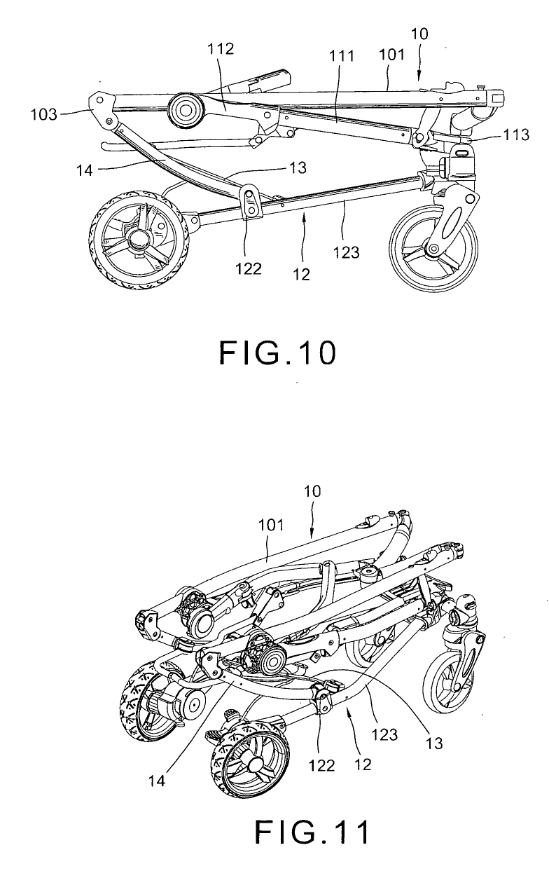

When folding the stroller, the handlebar unit 10 is pivoted about the joints 112 on the front leg unit 11, and the support tubes 14 are pivoted backward when the lower end of the handlebar unit 10 is pivoted backward. The dual cross link unit 13 is pivotably connected between the support tubes 14 and the rear leg tubes 123 of the chassis unit 12, so that when the support tubes 14 are pivoted backward, the distance between the support tubes 14 and the dual cross link unit 13 on the rear leg tubes 123 is increased, so that the dual cross link unit 13 pivots the two sides of the stroller toward each other to fold the stroller as shown in FIGS. 10 and 11.

While we have shown and described the embodiment in accordance with the present invention, it should be clear to those skilled in the art that further embodiments may be made without departing from the scope of the present invention.

What is claimed is:

1. A baby stroller comprising:
a handlebar unit, a front leg unit, a chassis unit, a dual cross link unit and support tubes, the handlebar unit pivotally connected to the front leg unit by two joints on the front leg unit;
the support tubes connected to the handlebar unit by two handlebar movable members on the handlebar unit, the support tubes connected to the chassis unit by two chassis fixing members on the chassis unit;
the dual cross link unit connected to the support tubes by connection heads on the dual cross link unit, the dual cross link unit and the chassis unit connected to chassis fixing members by the connection heads on the dual cross link unit, and
the front leg unit connected to the chassis unit by a chassis limitation member on the chassis unit.

2. The stroller as claimed in claim 1, wherein the handlebar unit comprises a handlebar tube, two handlebar fixing members and two pins, the handlebar tube is connected to the handlebar fixing members and pivotably connected to the handlebar movable members, the joints each have a slot and the pins extend through the slots.

3. The stroller as claimed in claim 1, wherein the front leg unit comprises two front leg tubes, a first foot rest, a second foot rest, a first connection frame and a second connection frame, the front leg tubes are connected to the joints and the first connection frame, the second connection frame is connected to the first foot rest which is movably connected to the second foot rest.

4. The stroller as claimed in claim 1, wherein the chassis unit comprises two rear leg tubes, two chassis fixing members, a front wheel unit and a rear wheel unit, the chassis limitation member is connected to the rear leg tubes, the front wheel unit is connected to the chassis limitation member, the two chassis fixing members are connected to the two rear leg tubes, the rear wheel unit is connected to the two rear leg tubes.

5. The stroller as claimed in claim 1, wherein the dual cross link unit comprises a first cross link and a second cross link which is pivotably connected to the first cross link, two respective top ends of the first cross link are pivotably connected to the support tubes by the connection heads, a lower end of the second cross link is pivotably connected to the chassis fixing members by the connection heads.
